(19) United States
(12) Patent Application Publication
(10) Pub. No.: US 2012/0181343 A1
(43) Pub. Date: Jul. 19, 2012

(54) PRESTRESSED CONCRETE SLEEPER AND METHOD FOR TRANSPORTING AND INSTALLING A SWITCH HAVING PRESTRESSED CONCRETE SLEEPERS

(75) Inventors: Frithjof Schimpff, Wiesbaden (DE); Hans-Dieter Mueller, Bochum (DE)

(73) Assignees: RAIL.ONE GMBH, Neumarkt (DE); DB NETZ AG, Frankfurt am Main (DE)

(21) Appl. No.: 13/498,677

(22) PCT Filed: Oct. 12, 2010
(86) PCT No.: PCT/EP2010/006208

§ 371 Date: Mar. 28, 2012

(30) Foreign Application Priority Data
Oct. 14, 2009 (DE) 10 2009 049 411.1

(51) Int. Cl. E01B 3/28; E01B 3/36; B23P 11/00

(52) U.S. Cl. 238/84; 29/428

(57) ABSTRACT

The invention relates to a prestressed concrete sleeper, having at least two sleeper sections that can be coupled or are coupled rigidly by a connection device embedded in the sleeper heads, wherein the sleeper sections each comprise a concrete in the region adjacent to the connection device which has a higher rigidity than the concrete in the other regions

The invention relates to a prestressed concrete sleeper having at least two sleeper sections that can be coupled or are coupled rigidly by a connection device embedded in the sleeper heads.

In the past, switches were assembled at the intended installation location from separately supplied concrete sleepers, rails and switch linkages. Since switches, because of the demanded high precision are completely preassembled in the manufacturing plant for verification, this procedure is particularly work-intensive. It has therefore been already proposed to transport and install preassembled switches in the preassembled state to the construction site. However, such switches exceed the size of the wagons that are available, so that one has taken to dividing pre-assembled switches in order to be able to transport them. The assembly and installation of the switch subsequently takes place at the place of installation.

From EP 1 026 321 A1 a steel connection device for iron railway sleepers is known, with which prefabricated prestressed sleeper components can be subsequently connected into sleeper units in a bending, tension and thrust-resistant manner, so that the switch during the assembly can be installed flat and as scheduled. In the region of the sleeper heads of the individual sleeper sections of a prestressed concrete sleeper, steel connection devices are embedded, which stand out at the face end of the sleeper sections and lead into webs that can be screwed together by means of screw connections.

An alternative rigid connection device for concrete sleepers is known from EP 1 908 880 A1. There it is proposed to clamp steel head plates on both sides of the butt joint against the end faces of the concrete and to connect them via steel clamps. Such connection devices however have the disadvantage that they are relatively complicated and thus cost-intensive, so that it is questionable if their use is economical.

In addition to this, it was established during tests that the coupling region between two sleeper sections, in which the embedded connection devices are located, is a potential weak point. This is attributed to the prestress, which is created through prestressed tension wires starting out from the sleeper heads, being merely gradually established. The prestressing force is thus low in the vicinity of a sleeper head and reaches the required level only at some distance from the connection device.

The invention is therefore based on the object of stating a prestressed concrete sleeper that is able to securely absorb the loads also in the region of the coupling of two sleeper sections.

To solve this object, it is provided according to the invention with a prestressed concrete sleeper of the type mentioned at the outset, that the sleeper sections in the region adjoining the connection device each consist of a concrete having a higher strength than the concrete in the remaining region.

Other than with conventional prestressed concrete sleepers, the invention is based on the realisation that the required better mechanical properties of the prestressed concrete sleeper can be achieved through the selection of a concrete with improved properties, in contrast for example to the use of additional concrete steels or the like. The invention, by contrast, provides that in this region a concrete with higher strength is used, which offsets the insufficient prestressing. The use of this concrete with higher strength in this case is limited to the region adjoining the connection device, following this a conventional concrete can be used.

With the prestressed concrete sleeper according to the invention it is particularly preferred that the concrete having the higher strength is high-strength or ultra high-strength concrete (UHPC/UHFB). Such concretes do not only have higher compressive strengths but also higher tensile strengths, so that ultra high-strength concrete in the present case is particularly well suited to offset the missing prestress. The ultra high-strength concrete used with the prestressed concrete sleeper according to the invention can have a tensile strength of at least 10 MPa, preferentially at least 20 MPa.

A further increase of the tensile strength can be achieved if the high-strength or ultra high-strength concrete with the prestressed concrete sleeper according to the invention comprises fibres. Possible fibres are in particular steel fibres, plastic fibres, glass fibres or carbon fibres. The various mentioned fibres can also be employed in different compositions in combinations with one another.

It is also within the scope of the invention that the concrete of the prestressed concrete sleeper according to the invention having the higher strength is polymer concrete. Polymer concrete, which is also called synthetic resin-bonded concrete, likewise has a high tensile strength compared to normal concrete, so that when using polymer concrete the loads that occur in the region of a connection device of the prestressed concrete sleeper can be absorbed, although the prestressing in this region is below the desired value.

A further reinforcement can be obtained with the prestressed concrete sleeper according to the invention in that in the sleeper heads at least one bracket each of concrete steel is arranged. Through this bracket, the tolerable forces and moments can be further increased, so that the required load carrying capacities can also be achieved in the critical coupling region between two sleeper sections.

The prestressed concrete sleeper according to the invention is suitable in particular as switch sleeper, since the transport of preassembled sleepers can be simplified, in that the switches are folded up or folded over. The connection device of the prestressed concrete sleeper is therefore preferentially designed as screw connection, so that the screws can be disconnected or removed for folding up or over. Following the disconnection of the screw connection, the loosened screw connection acts as joint, as a result of which the folding over is made possible.

It can also be provided within the scope of the invention that in the region of the connection device a removable transport joint is attached in order to fold over the sleeper sections. Following the folding over approximately by 180°, the prestressed concrete sleeper can be transported to the intended place of installation using a conventional goods wagon.

In addition to this, the invention relates to a method for the transport and installation of a switch with prestressed concrete sleepers of the related type.

The following steps are provided with the method according to the invention: preassembly of the prestressed concrete sleepers with rails into a switch, disconnecting a part of the screws in the connection device, folding over of the moveable part of the switch, loading and transport of the switch to the place of installation, folding over of the moveable part of the switch back into the starting position, assembling and tightening the screws and assembling the rails.

Preferentially, all screws of the connection device are removed with the method according to the invention and a removable transport joint is attached in order to fold over the sleeper sections.

Further advantages and details of the invention are described by means of exemplary embodiments making reference to the drawings. The drawings are schematic representations and show:

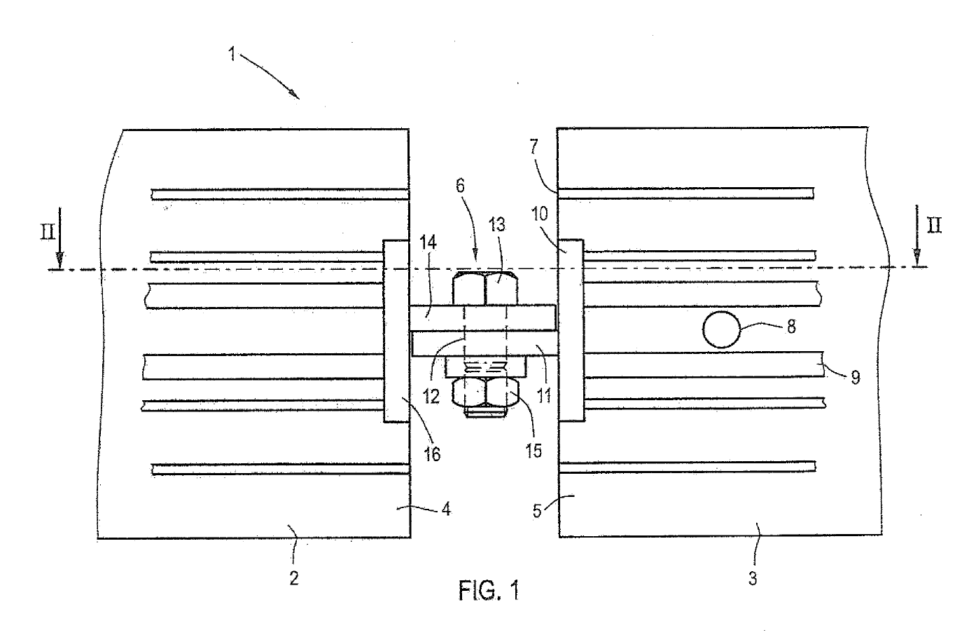

FIG. 1 an enlarged detail of a prestressed concrete sleeper according to the invention in the region of the coupling of two sleeper sections in a top view;

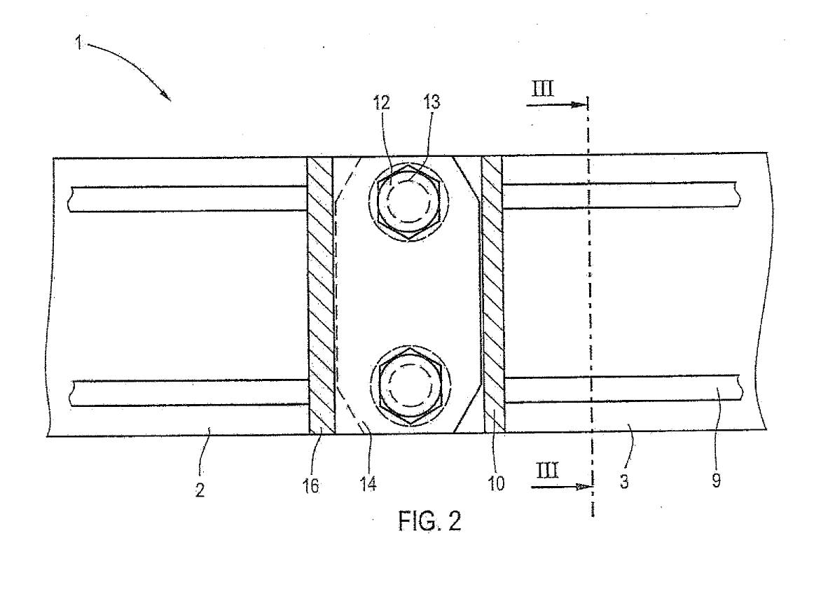

FIG. 2 a lateral view of the prestressed concrete sleeper shown in FIG. 1 along the line II-II sectioned;

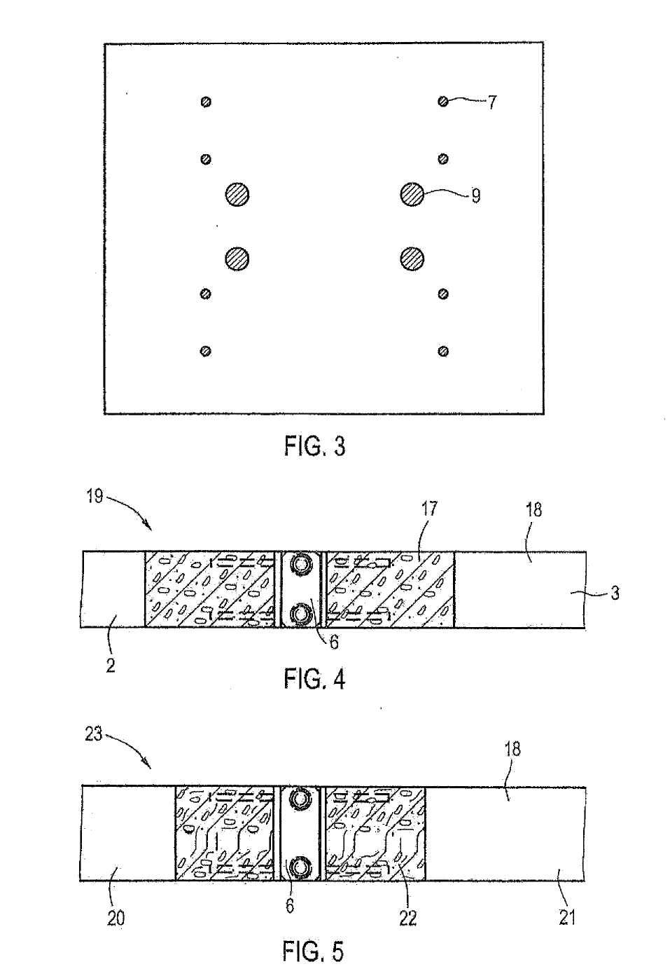

FIG. 3 a section through the prestressed concrete sleeper shown in FIG. 2 along the line III-III sectioned;

FIG. 4 a detail of a prestressed concrete sleeper according to the invention in a lateral view;

FIG. 5 a further exemplary embodiment of a prestressed concrete sleeper according to the invention in a lateral view;

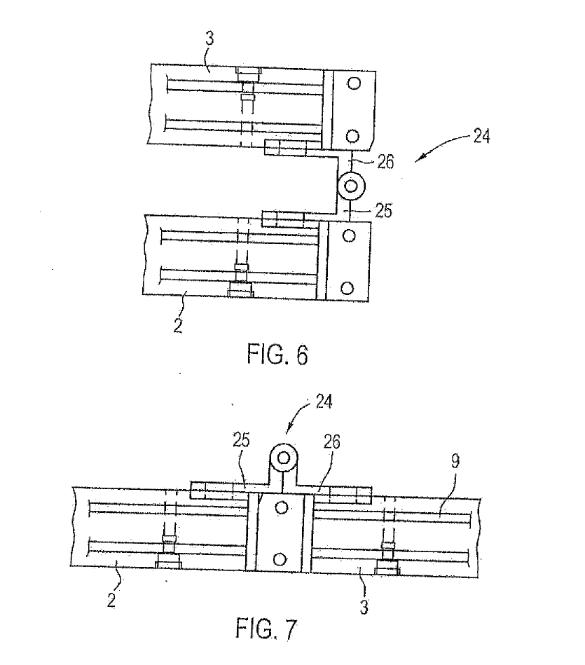

FIG. 6 a prestressed concrete sleeper according to the invention with a transport joint; and

FIG. 7 the prestressed concrete sleeper of FIG. 6 in folded-back position.

FIG. 1 shows in a top view a prestressed concrete sleeper 1 with sleeper sections 2, 3, which are rigidly coupled by means of a connection device 6 embedded in the sleeper heads 4, 5.

Each sleeper section 2, 3 has a plurality of tensioning wires 7, through which the sleeper sections 2, 3 are subjected to a prestressing force in the form of a compressive force. The assembly of the rails is carried out via through-holes, of which for simplification merely one through-hole 8 is shown in the sleeper section 3.

The welded, steel connection device 6 in the exemplary embodiment shown comprises four steel bars 9 each, which are arranged in longitudinal direction of the prestressed concrete sleeper 1 and welded to a head plate 10. The head plate 10 terminates flush with the outside of the sleeper section 2, 3. On the outside of the head plate 10, a welded-on web 11 is located, through the through-hole 12 of which a fastening screw 13 can be inserted. As is best visible in FIG. 2, the web 14 has two through-holes 12. The head plate 16 embedded in the sleeper section 2 is constructed symmetrically, merely the position of the web 14 is suitably displaced. Following the tightening of the fastening screw 13 against a nut 15, the sleeper sections 2, 3 of the prestressed concrete sleeper 1 are rigidly coupled to each other. When the screw connection formed by the fastening screw 13 and the nut 15 is loosened, a joint with the longitudinal axis of the fastening screw 13 as rotary axis is created, about which the sleeper sections 2, 3 can be pivoted, so that the prestressed concrete sleeper 1 can be folded over or up entirely or partially in order to simplify its transport.

In the lateral view shown in FIG. 2 one can see that the front web 14, which is welded to the left head plate 16, bears against the head plate 10 in FIG. 2 on the right in an almost flat manner, as a result of which the rigid coupling of the sleeper sections 2, 3 is achieved.

FIG. 3 is a section along the line in FIG. 2 and shows the position of the tension wires 7 and the steel bars 9. However, this drawing must only be understood as an example, the number and the position of the tension wires and the steel wires in each case is selected as a function of the desired application purpose.

FIG. 4 shows schematically the coupling region of two sleeper sections 2, 3 of a prestressed concrete sleeper 19. For the sake of clarity, no tension wires are shown in FIG. 4. In the region of the connection device 6 and in a determined region beyond that, the sleeper sections 2, 3 consist of a high-strength or ultra high-strength concrete 17, which has a higher strength than the concrete 18 in the remaining region, which is a standard concrete. The high-strength or ultra high-strength concrete 17 is reinforced with steel fibres. Through the high-strength or ultra high-strength concrete 17, the reduced tensile strength, which prevails in the region of the sleeper heads, is compensated since there the prestressing caused through the tension wires is not or not yet present to an adequate degree. Through the high-strength or ultra high-strength concrete 17, the prestressed concrete sleeper 17 has an adequate strength in this region, so that the loads that occur can be securely tolerated. The ultra high-strength concrete 17 shown in FIG. 4 has a tensile strength of 20 MPa.

FIG. 5 shows a further exemplary embodiment of a prestressed concrete sleeper 23 in the region of the coupling of two sleeper sections 20, 21. The fundamental construction corresponds to that of the exemplary embodiment shown in FIG. 4, in particular, the prestressed concrete sleeper shown in FIG. 5 also comprises the connection device 6. Other than in the preceding exemplary embodiments, the sleeper sections 20, 21 in the region adjoining the connection device 6 consist of polymer concrete 22. Following the polymer concrete 22, the prestressed concrete sleeper 23 consists of normal concrete 18.

In the switch plant, the prestressed concrete sleepers are preassembled with rails into a switch. In order to adhere to the transport space of transport wagons that is available, sections of the switch which exceed this space are folded over. To this end, the rail of a protruding part is at least partially removed again and transported separately. The coupled-on sleepers of this region are lifted after the removing and loosening of screw connections, wherein the screw connection forms the rotary axis, so that they can be folded up and transported on normal wagons. At the installation location of the switch, the folded-up sections of the switch sleepers are again folded back into the desired position, the removed screws are reinstalled, all screws are tightened so that the respective sleeper sections are again rigidly connected to each other. The rail removed for the transport is re-assembled. Through this procedure it is ensured that the geometry of the switch established in the switch plant is present also after the installation.

In FIGS. 6 and 7 a prestressed concrete sleeper is shown, on which a removable transport joint 24 is attached, in order to fold over the sleeper sections 2, 3 and transport the concrete sleeper in the folded-over state. For the sake of better clarity, only the substantial components are shown in FIGS. 6 and 7. The transport joint 24 with its joint sections 25, 26 is fastened to the top of the sleeper sections 2, 3 to be coupled. For transport, the fastening screws for the web between the sleeper sections 2, 3 are removed. Following this, the shorter of the two sleeper sections is tilted by 180° without loosening of the rail being required in the process. In this folded-back state the prestressed concrete sleeper can be transported with a normal goods wagon. At the intended place of installation, the folded-over sleeper section is folded back and the sleeper sections are again connected to each other via the webs by means of through-screws. Following this, the transport joint 24 is removed.

1. A prestressed concrete sleeper having at least two sleep sections which can be or are rigidly coupled by means of a connection device embedded in the sleeper heads, wherein the sleeper sections (2, 3) in the region adjoining the connection device (6) each consist of a concrete having a higher strength than the concrete in the remaining region.

2. The prestressed concrete sleeper according to claim 1, wherein the concrete having the higher strength is high-strength or ultra high-strength concrete (UHPC/UHFB).

3. The prestressed concrete sleeper according to claim 2, wherein the high-strength or ultra high-strength concrete has a tensile strength of at least 10 MPa, preferentially at least 20 MPa.

4. The prestressed concrete sleeper according to claim 2, wherein the high-strength or ultra high-strength concrete comprises fibres, in particular steel fibres and/or plastic fibres and/or glass fibres and/or carbon fibres.

5. The prestressed concrete sleeper according to claim 1, wherein the concrete having the higher strength is polymer concrete.

6. The prestressed concrete sleeper according to claim 1, wherein in the sleeper heads at least one bracket of concrete steel each is arranged.

7. The prestressed concrete sleeper according to claim 1, wherein it is designed as switch sleeper.

8. The prestressed concrete sleeper according to claim 1, wherein the connection device (6) is designed as screw connection, which with a loosened screw and removed remaining screws acts as joint.

9. The prestressed concrete sleeper according to claim 1, wherein in the region of the connection device a removable transport joint (24) is attached in order to fold over the sleeper sections (2, 3).

10. A method for the transport and installation of a switch with prestressed concrete sleepers according to claim 1, comprising the following steps:
preassembling the prestressed concrete sleepers with rails into a switch;
loosening a part of the screws of the connection device;
folding over the moveable part of the switch;
loading and transporting the switch to the place of installation;
folding over of the moveable part of the switch back into the starting position;
assembling and tightening the screws; and
assembling the rails.

11. The method according to claim 10, wherein all screws of the connection device are loosened or removed and a removable transport joint is attached in order to fold over the sleeper sections for the transport.
